(19) United States
(12) Patent Application Publication
(10) Pub. No.: US 2026/0284807 A1
(43) Pub. Date: Sep. 24, 2026

(54) CLAMP DEVICE

(71) Applicant: MAYEKAWA MFG. CO., LTD., Tokyo (JP)

(72) Inventors: Hiroshi KOJIMA, Tokyo (JP); Kakeru TOUJO, Tokyo (JP); Tomoki MATSUO, Tokyo (JP); Takefumi HAPPO, Tokyo (JP); Michiyuki NAKA, Tokyo (JP)

(21) Appl. No.: 18/998,011

(22) PCT Filed: Sep. 22, 2023
(86) PCT No.: PCT/JP2023/034450

§ 371 Date: Jan. 23, 2025

(30) Foreign Application Priority Data
Jul. 26, 2022 (JP) 2022-118768

(51) Int. Cl. B23K 37/0533

(52) U.S. Cl. CPC B23K 37/0533

(57) ABSTRACT

A clamp device clamps outer circumferential surfaces of a pair of pipe members while having end surfaces of the pair of pipe members to be welded facing each other. The clamp device includes a plurality of clamping portions, and a projecting piece. The clamping portions clamp outer circumferential surfaces of the pair of pipe members. The projecting piece is provided on at least one clamping portions. The projecting piece is inserted between the end surfaces of the pair of pipe members.

### CROSS-REFERENCE TO RELATED APPLICATIONS

This application is the U.S. National Stage entry of International Application No. PCT/JP2023/034450, filed on Sep. 22, 2023, which, in turn, claims priority to Japanese Patent Application No. 2022-118768, filed on Jul. 26, 2022, both of which are hereby incorporated herein by reference in their entireties for all purposes.

### TECHNICAL FIELD

The present invention relates to a clamp device configured to clamp a pipe member.

### BACKGROUND ART

When end surfaces of metal pipe members are welded together, there is a case in which the end surfaces are placed opposite with each other and a plurality of places on both of the end surfaces are temporarily welded in such state. In this case, circumferential regions of both of the end surfaces are regularly welded after the end surfaces of the pipe members are temporarily welded together.

In such welding work, when the pipe members are temporarily welded, outer circumferential surfaces of both pipes are clamped by a clamp device in a state in which the end surfaces of the pipe member are opposite to each other. Here, since the outer circumferential surfaces of the pair of pipe members are clamped by the clamp device, the posture is stabilized in a state in which the end surfaces are faced with each other. The pair of pipe members are temporarily welded by a worker at a plurality of places in the circumferential regions of the end surfaces while maintaining this posture.

Various clamp devices have been proposed for such purposes in the related art (for example, see Patent Documents 1 and 2).

A clamp device disclosed in Patent Document 1 includes a main frame part having substantially a J shape when seen in a front view, and an auxiliary arm part held on a linear portion of the main frame part to be position-adjustable, and an operating rod is screwed into the auxiliary arm part in a penetrating state. A tip portion of the operating rod faces a curved tip portion of the main frame part. A pad member is attached to each tip portion of the main frame part and the operating rod. A flat surface abutting an outer circumferential surface of the pipe member is formed on each pad member. In addition, a grip portion configured to rotate the operating rod is provided on a base end side of the operating rod.

When the pipe members are clamped by the clamp device, a locking position of the auxiliary arm part with respect to the main frame part is appropriately adjusted, and the pair of pipe members are disposed between the pad members on the side of the main arm part and the pad members on the side of the operating rod. In this state, the worker grasps the grip portion and rotates the operating rod in a predetermined direction, thereby displacing the operating rod in a tip direction of the main frame part. Accordingly, the pad members on the side of the main frame part and the pad members on the side of the operating rod are pressed against the outer circumferential surfaces of the pair of pipe members on each flat surface. As a result, the pair of pipe members are clamped by the pair of pad members, while having their end surfaces facing each other.

A clamp device disclosed in Patent Document 2 includes a clamping portion on a fixed side and a clamping portion on a movable side that approaches and moves away from the clamping portion on the fixed side, and a pair of pad members are swingably attached to the clamping portions on the fixed side and the movable side. A flat surface that abuts an outer circumferential surface of the pipe member is formed on each pad member. When the pair of pad members attached to each of the clamping portions are pressed against the outer circumferential surfaces of the pipe members, the inclination angles of each of the flat surfaces are automatically adjusted so as to conform with the outer circumferential surfaces of the pipe members. As a result, the pair of pipe members are stably clamped by the pair of flat surfaces inclined in a V shape of each of the clamping portions.

### CITATION LIST

### Patent Document

Patent Document 1: Japanese Patent No. 5311093

Patent Document 2: European Patent No. 300473

### SUMMARY OF INVENTION

### Technical Problem

The clamp devices described in Patent Documents 1 and 2 are both designed so that the flat surfaces of the pad members abut against the outer circumferential surfaces of the pair of pipe members. For this reason, in order to properly adjust a gap (root gap) between the end surfaces of the pair of pipe members, complicated adjustment work is required at the work site, and in order to properly adjust the gap between the end surfaces of the pair of pipe members in a short time, workers must be skilled.

Then, if the gap (root gap) between the end surfaces of the pair of pipe members is too wide or too narrow, it is likely to cause poor welding during regular welding.

An aspect of the present invention is directed to providing a clamp device capable of easily keeping a gap between end surfaces of a pair of clamped pipe members constant.

### Solution to Problem

A clamp device according to an aspect of the present invention is a clamp device configured to clamp outer circumferential surfaces of a pair of pipe members while having end surfaces of the pair of pipe members to be welded facing each other, the clamp device including: a plurality of clamping portions configured to clamp the outer circumferential surfaces of the pair of pipe members; and a projecting piece that is provided on at least one of the clamping portions and that is inserted between the end surfaces of the pair of pipe members.

In the above-mentioned configuration, is a case the outer circumferential surfaces of the pair of pipe members are clamped, the projecting piece of the clamping portion is inserted between the end surfaces of the pair of pipe members, and the projecting piece abuts each of the end surface of the pipe members. In this state, when the outer circumferential surfaces of the pair of pipe members are clamped by the plurality of clamping portions, a gap between the end surfaces of both the pipe members is kept at a constant interval by the projecting piece. As the pair of pipe members are clamped by the clamping device in this way, temporary welding can be performed appropriately between the end surfaces of the pipe members.

The clamping portions may have a flat surface configured to abut the outer circumferential surface of the pair of pipe members, and the projecting piece may be provided so as to protrude from the flat surface.

In this case, as the flat surfaces of the clamping portions abut the outer circumferential surfaces of the pair of pipe members, the pipe members can be stably clamped. In addition, since the projecting piece is provided so as to protrude from the flat surfaces abutting the outer circumferential surfaces of the pipe members, end portions of each of the pipe members can be stably positioned by the flat surface and the projecting piece.

The clamping portion may include: a support member; and a pair of pad members that are swingably supported by the support member, each of the pair of pad member having the flat surface, and wherein each of the flat surfaces of the pair of pad members may receive a pressing load and abut the outer circumferential surfaces of the pair of pipe members.

In this case, when a pressing load is applied to the support member, the flat surfaces of the pad members abut the outer circumferential surfaces of the pair of pipe members. Here, the pad members receive a reaction force from the pipe members and swing in an appropriate posture. As a result, the pair of pad members supported by the support members have flat surfaces inclined in a V-shape, and the outer circumferential surfaces of the pair of pipe members can be stably clamped in this posture.

The clamping portion may be constituted by: a fixed-side clamping portion; and a movable-side clamping portion that approaches or moves away with respect to the fixed-side clamping portion, and the projecting piece may be provided only on the pad member of the fixed-side clamping portion.

In this case, when the pair of pipe members are clamped, first, the outer circumferential surfaces of both the pipe members abut the flat surfaces of the pad members of the fixed-side clamping portions. Here, by adjusting the posture and interval of both the pipe members, the end surfaces of the pipe members abut the projecting piece on the flat surface. After that, the movable-side clamping portion is made to approach toward the fixed-side clamping portion, and the flat surfaces of the pad members of the movable-side clamping portion are made to abut the outer circumferential surfaces of both the pipe members. Accordingly, the gap between the end surfaces of the pair of pipe members is adjusted to a constant value by the projecting pieces, and in this state, the pair of pipe members are clamped by the clamp device. In this configuration, since no projecting piece is provided on the pad member of the movable-side clamping piece, when the pair of pipe members are disposed between the pad members of both the clamping portions, there is no need to space the movable-side clamping portion excessively away from the fixed-side clamping portion. Accordingly, when this configuration is employed, the clamping operation with respect to the pair of pipe members can be more easily performed.

### Advantageous Effects of Invention

In the clamp device according to the aspect of the present invention, since the projecting piece inserted between the end surfaces of the pair of pipe members is provided on the clamping portion, the gap between the end surface of the pair of clamped pipe members can be easily kept constant by abutting the projecting piece against the end surfaces of the pair of pipe members and clamping the pipe members.

### BRIEF DESCRIPTION OF DRAWINGS

FIG. 1 is a front view of a clamp device of an embodiment.

FIG. 2 is a side view of the clamp device of the embodiment that clamps a pair of pipe members.

FIG. 3 is a front view of the clamp device of the embodiment that clamps the pair of pipe members.

FIG. 4 is a cross-sectional view along line IV-IV in FIG. 3.

FIG. 5 is a side view showing an aspect in which the pair of pipe members are welded.

### DESCRIPTION OF EMBODIMENTS

Hereinafter, an embodiment of the present invention will be described with reference to the accompanying drawings.

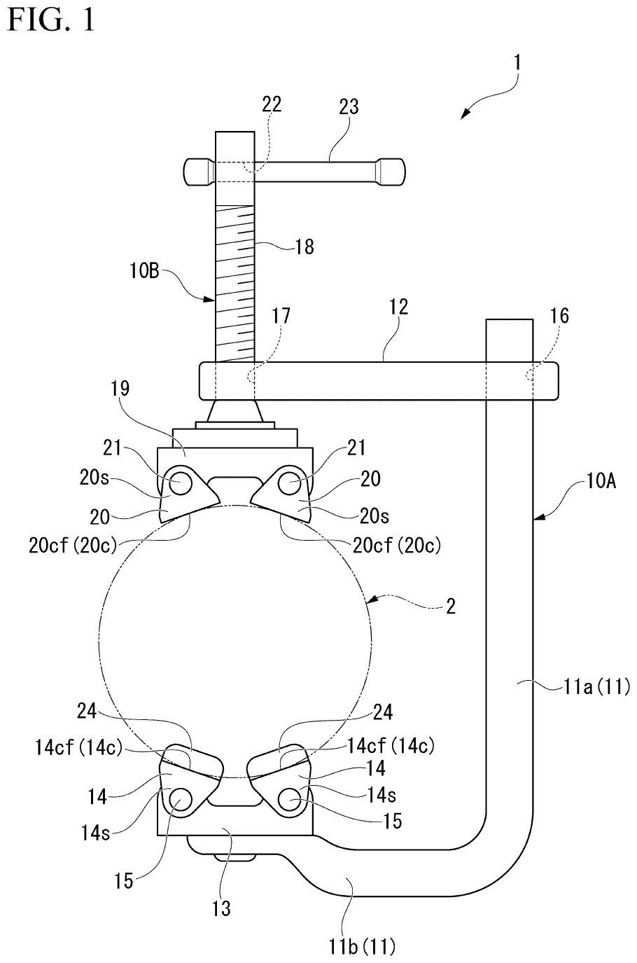

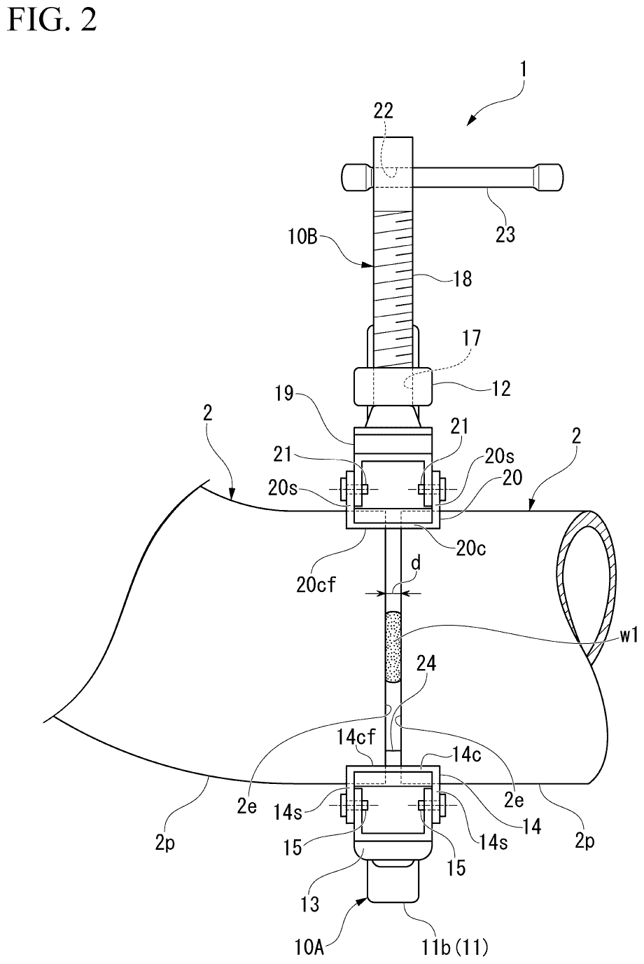

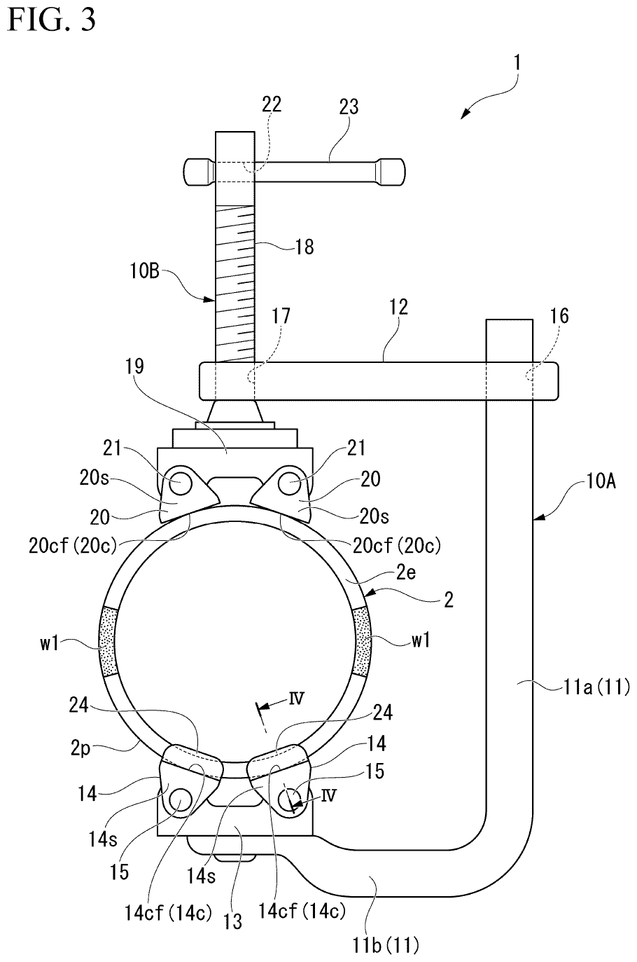

FIG. 1 is a front view of a clamp device 1 of the embodiment. FIG. 2 and FIG. 3 are a side view and a front view of the clamp device 1 that clampes a pair of pipe members 2. Further, FIG. 3 is a front view of one pipe member 2 of the pair of pipe members 2, which are having end surfaces 2e facing each other, from the side of the end surface 2e.

The clamp device 1 is a device configured to clamp outer circumferential surfaces 2p of the pair of pipe members 2 which have the end surfaces 2e to be welded facing each other. The clamp device 1 maintains a constant opposing posture of the pair of pipe members 2 when welding the end surfaces 2e of the pair of pipe members 2 together, thereby facilitating temporary welding work of the end surfaces 2e of the pipe members 2 by a worker.

Further, in the specification, “the pipe members” are not limited to linear pipelines and include substantially L-shaped elbow fittings, substantially T-shaped cheese fittings, or the like.

The clamp device 1 includes a fixed-side clamping portion 10A (a clamping portion on a fixed side), and a movable-side clamping portion 10B (a clamping portion on a movable side) that approaches and moves away from the fixed-side clamping portion 10A.

The fixed-side clamping portion 10A includes an L-shaped block 11 having substantially an L shape when seen in a front view, and a locking block 12 held in the L-shaped block 11 to be adjustable in position. The L-shaped block 11 includes a base arm 11a extending linearly in one direction, and a support arm 11b extending from one end portion of the base arm 11a in a longitudinal direction and bent at a substantially right angle.

One end portion side of the locking block 12 is held on the base arm 11a of the L-shaped block 11. The locking block 12 is capable of being adjusted in position in an extension direction of the base arm 11a. A pad support block 13 (support member) is fixed to a surface of the support arm 11b which faces the locking block 12. A pair of pad members 14 are swingably supported in the pad support block 13 so as to be swingable apart in the extension direction of the support arm 11b. Each of the pad members 14 is swingably supported by a pivot shaft 15 extending in a direction perpendicular to each extension direction of the base arm 11a and the support arm 11b (a direction along an axial direction of the gripped pipe members 2). The pad members 14 will be described below in detail.

The locking block 12 is a block extending linearly in one direction, and the one end portion side of the locking block 12 is held on the base arm 11a of the L-shaped block 11 to be position-adjustable. An engaging hole 16 through which the base arm lla passes is formed in one end side of the locking block 12. A concavo-convex portion (not shown) is formed on an outer surface of the base arm 11a. When a load in a direction perpendicular to the extension direction of the locking block 12 is input to the other end side of the locking block 12, the engaging hole 16 is engaged with the concavo-convex portion on the outer surface of the base arm 11a, and thus, the position of the locking block 12 is fixed with respect to the base arm 11a.

The other end side of the locking block 12 is formed with a screw hole 17 in which a female thread is formed. The screw hole 17 is formed approximately parallel to the base arm 11a of the L-shaped block and penetrates the locking block 12. An operating rod 18 in which a male thread is formed on an outer circumferential surface thereof is screwed into the screw hole 17. The operating rod 18 constitutes a main part of the movable-side clamping portion 10B.

The operating rod 18 has a pad support block 19 (support member) fixed to one end side of the operating rod 18 in the axial direction (a side facing the pad member 14 on the side of the L-shaped block 11). A pair of pad members 20 are supported on the pad support block 19 in a swingable manner while being spaced apart in the extension direction of the locking block 12. Each of the pad members 20 is supported on a pivot shaft 21, which extends in a direction perpendicular to each extension direction of the base arm 11a and the support arm 11b of the L-shaped block 11 (a direction along an axial direction of the pipe members 2 to be gripped), in a swingable manner.

As the operating rod 18 is rotated, the pad support block 19 and the pair of pad members 20 approach or move away from the pad support block 13 and the pair of pad members 14 which are disposed at the side of the facing L-shaped block 11. When the operating rod 18 is operated to rotate in one direction, the pad support block 19 on the side of the operating rod 18 moves in a direction in which the pad support block 19 approaches the pad support block 13 on the side of the L-shaped block 11. In addition, when the operating rod 18 is operated to rotate in the other direction, the pad support block 19 on the side of the operating rod 18 moves in a direction in which the pad support block 19 moves away from the pad support block 13 on the side of the L-shaped block 11.

A through-hole 22 extending in a direction crossing the axial direction of the operating rod 18 is formed on the other end side of the operating rod 18 in the axial direction. A grip rod 23 is slidably inserted through the through-hole 22. The grip rod 23 is the part that a worker holds to rotate the operating rod 18, for example, when clamping the pipe members 2 with the clamp device 1.

Further, in the embodiment, the fixed-side clamping portion 10A (the clamping portion on the fixed side) is constituted by the L-shaped block 11, the locking block 12, the pad support block 13, the pad members 14, and the like. In addition, the movable-side clamping portion 10B (the clamping portion on the movable side) is constituted by the operating rod 18, the grip rod 23, the pad support block 19, the pad members 20, and the like.

As shown in FIG. 3, each of the pad members 14 on the side of the L-shaped block 11 (the fixed-side clamping portion 10A) includes a pair of sidewalls 14s having a triangular shape when seen in a side view, and a substantially rectangular clamping wall 14c continuous with the pair of sidewalls 14s. The clamping wall 14c is continuous with one side of the pair of sidewalls 14s. The pair of sidewalls 14s are swingably supported on the pad support block 13 by the pivot shaft 15 at diagonal portions with respect to the side continuous with the clamping wall 14c. An outer surface of the clamping wall 14c is set as a flat surface 14cf abutting the outer circumferential surfaces 2p of the pipe members 2. Hereinafter, regarding the flat surface 14cf, the direction in which the axial center of the pivot shaft 15 extends is simply referred to as the “axial center direction.”

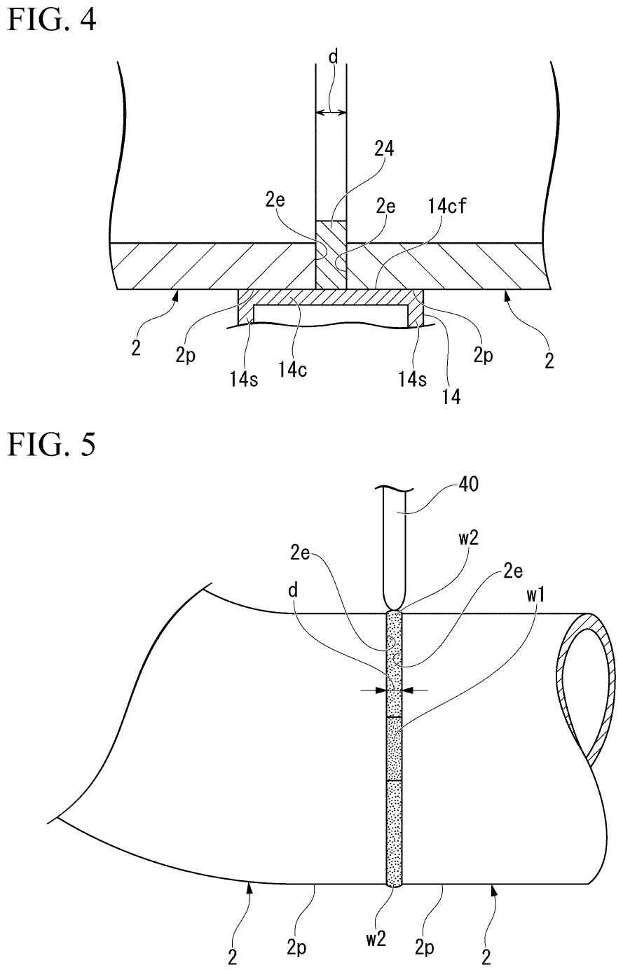

FIG. 4 is a cross-sectional view along line IV-IV in FIG. 3.

Rectangular plate-shaped projecting pieces 24 is provided so as to protrude from the flat surfaces 14cf of the pad members 14, respectively. The projecting piece 24 is constituted by a plate member with an approximately constant thickness and extends perpendicular to the flat surface 14cf and the pivot shaft 15. As shown in FIG. 2 and FIG. 4, the projecting piece 24 is provided so as to protrude in a substantially central position of the flat surface 14cf in the axial center direction. Each of the projecting pieces 24 is inserted between the end surfaces 2e of the pair of pipe members 2 when the pair of pipe members 2 are clamped between the pad members 14 of the fixed-side clamping portion 10A and the pad members 20 of the movable-side clamping portion 10B in a state in which the end surfaces 2e of the pair of pipe members face each other.

Here, both sides of each of the projecting pieces 24 facing in opposite directions are abutted against each of the end surfaces 2e of the pipe members 2. Accordingly, a gap d between the end surfaces 2e of the pair of pipe members 2 is a gap equal to the thickness of the projecting piece 24.

In addition, as shown in FIG. 3, each of the pad members 20 on the side of the operating rod 18 (the movable-side clamping portion 10B) includes, like the pad member 14 on the side of the L-shaped block 11, a pair of sidewalls 20s having a triangular shape when seen in a side view, and substantially rectangular clamping walls 20c continuous with the pair of sidewalls 20s. The pair of sidewalls 20s are swingably supported on the pad support block 19 by the pivot shaft 21. Outer surfaces of the clamping walls 20c are flat surfaces 20cf abutting the outer circumferential surfaces 2p of the pipe members 2. However, the pad members 20 on the side of the operating rod 18 are not provided with the projecting pieces 24 on the flat surfaces 20cf.

Next, a specific example when the pair of pipe members 2 are welded will be described.

### Temporary Welding of Pipe Members

First, the end surfaces 2e of the pair of pipe members 2 face each other, and a plurality of places of the circumferential regions of the end surfaces 2e are temporarily welded. When the temporary welding is performed, the clamp device 1 described above is used to keep the gap d between the end surfaces 2e of the pipe members 2 constant.

In advance, the operating rod 18 of the clamp device 1 is rotated in a predetermined direction, and the pad support block 13 of the movable-side clamping portion 10B is spaced for a predetermined distance from the pad support block 19 on the side of the fixed-side clamping portion 10A. Accordingly, a gap in which the pair of pipe members 2 can be disposed is provided between the pad members 14 on the side of the fixed-side clamping portion 10A and the pad members 20 on the side of the movable-side clamping portion 10B.

In this state, the clamp device 1 is moved to a position where the pair of pipe members 2 are disposed to face each other, and the pad members 14 on the side of the fixed-side clamping portion 10A abut the outer circumferential surfaces 2p of the pair of pipe members 2 from below. Here, the outer circumferential surfaces 2p of both the pipe members 2 abut each of the flat surfaces 14cf of the pair of pad members 14 on the side of the fixed-side clamping portion 10A. In this state, a relative position or angle of the pair of pipe members 2 is adjusted, and the end surfaces 2e of the pipe members 2 are abutted against side surfaces of the projecting pieces 24 of the pair of pad members 14.

Here, since the projecting pieces 24 are plates of constant width, the gap d of the end surfaces 2e of the pair of pipe members 2 is almost constant in the circumferential direction. In addition, the pair of pad members 14 has the flat surfaces 14cf abutting against the outer circumferential surfaces 2p of both the pipe members 2, so that the inclined posture is automatically adjusted around the pivot shaft 15.

After that, as a worker rotates the operating rod 18 of the clamp device 1 in a predetermined direction, the pad support block 19 of the movable-side clamping portion 10B is moved in a direction so that the pad support block 19 approaches the pad support block 13 of the fixed-side clamping portion 10A. Accordingly, the pair of pad members 20 on the side of the movable-side clamping portion 10B are pressed against the outer circumferential surfaces 2p of the pipe members 2. Here, each of the pad members 20 abuts the outer circumferential surfaces 2p of the pipe members 2 at the flat surfaces 20cf, and thus, the inclined posture of each of the pad members 20 is automatically adjusted around the pivot shaft 21.

As a result, the pair of pipe members 2 are clamped by the clamp device 1 in a state in which the gap d between the end surfaces 2e is constant. Here, each of the pad members 14 and 20 of the fixed-side clamping portion 10A and the movable-side clamping portion 10B have the pair of flat surfaces 14cf and 20cf inclined in an approximately V-shape to wrap around and press down the outer circumferential surfaces of both the pipe members 2.

The pair of pipe members 2, whose outer circumferential surfaces 2p are clamped by the clamp device 1 as described above, are welded by a welding device (not shown) at the plurality of places on the periphery of the end surfaces 2e of the both pipe members 2. Further, reference sign w1 in FIG. 2 and FIG. 3 designates temporary welding portions of the end surfaces 2e of the pipe members 2 (portions to which welding materials are attached).

### Main Welding of Pipe Members

FIG. 5 is a side view showing an aspect of performing main welding with respect to the pair of pipe members 2, which are temporarily fixed.

In the main welding, with respect to the pair of pipe members 2 in which the relative positions of the end surfaces 2e are fixed by the temporary welding, welding is performed on the remaining portion of the gap d between the end surfaces 2e.

Accordingly, the gap d between the end surfaces 2e of the pair of pipe members 2 is completely sealed by welding. Further, reference sign 40 in FIG. 5 designates a welding rod when the main welding is performed, and reference sign w2 designates a main welded portion between the end surfaces 2e of the pipe members 2 (a portion to which a welding material has attached).

As described above, in the clamp device 1 of the embodiment, the projecting piece 24 inserted between the end surfaces 2e of the pair of pipe members 2 is provided on at least one clamping portion (the fixed-side clamping portion 10A). For this reason, by abutting the projecting piece 24 against the end surfaces 2e of the pair of pipe members 2 and clamping the pipe members 2 using the fixed-side clamping portion 10A and the movable-side clamping portion 10B, the gap d between the end surfaces 2e of the pair of pipe members 2 to be clamped can be easily maintained constant.

Accordingly, when the clamp device 1 of the embodiment is employed, temporary welding can be easily and appropriately performed on the end surfaces 2 of the pair of pipe members 2 without requiring the skill of the worker.

Further, in the embodiment, while the projecting pieces 24 are provided on the side of the fixed-side clamping portion 10A, the projecting pieces 24 may be provided on the side of the movable-side clamping portion 10B. In addition, the projecting pieces 24 may be provided on both sides of the fixed-side clamping portion 10A and the movable-side clamping portion 10B.

In addition, in the clamp device 1 of the embodiment, the flat surfaces 14cf abutting the outer circumferential surfaces 2p of the pipe members 2 are provided on the clamping portion (the fixed-side clamping portion 10A), and the projecting pieces 24 protrude from the flat surfaces 14cf. For this reason, the pipe members 2 can be stably clamped by abutting the flat surfaces 14cf of the clamping portion (the fixed-side clamping portion 10A) against the outer circumferential surfaces 2p of the pair of pipe members 2. In addition, since the projecting pieces 24 protrude from the flat surfaces 14cf, each of the end portions of the pipe members 2 can be stably positioned by the flat surfaces 14cf and the projecting pieces 24.

Accordingly, when this configuration is employed, the gap d between the end surfaces 2e of the pair of pipe members 2 to be clamped can be easily and accurately adjusted.

In addition, in the clamp device 1 of the embodiment, each of the fixed-side clamping portion 10A and the movable-side clamping portion 10B include the pad support blocks 13 and 19 (support members), and the pair of pad members 14 and 20 swingably supported by the pad support blocks 13 and 19 and having the flat surfaces 14cf and 20cf. Then, when the fixed-side clamping portion 10A and the movable-side clamping portion 10B of the clamp device 1 are subjected to a pressing load by rotating operation of the operating rod 18, the flat surfaces 14cf and 20cf of each of the pad members 14 and 20 abut against the outer circumferential surfaces 2p of the pair of pipe members 2. Here, each of the pad members 14 and 20 receives a reaction force from the pipe member 2 and swings to the appropriate posture.

Accordingly, when this configuration is employed, the flat surfaces 14cf and 20cf of each pair of pad members 14 and 20 are inclined in a V-shape, and this posture allows them to stably clamp the outer circumferential surfaces 2p of the pair of pipe members 2. As a result, it is possible to keep the gap d between the end surfaces 2e of the pair of pipe members 2 constant and easily perform the temporary welding work on the end surfaces 2e of the pipe members 2.

Further, in the clamp device 1 of the embodiment, the projecting pieces 24 inserted between the end surfaces of the pipe members 2 are provided only on the pad members 14 of the fixed-side clamping portion 10A and is not provided on the pad members 20 of the movable-side clamping portion 10B. For this reason, when the outer circumferential surfaces 2p of the pair of pipe members 2 are clamped by the fixed-side clamping portion 10A and the movable-side clamping portion 10B, there is no need to space the movable-side clamping portion 10B excessively far from the fixed-side clamping portion 10A.

Accordingly, when the clamp device 1 of the embodiment is employed, even in an environment where it is difficult to secure a sufficient working space around the pipe members 2, the clamping operation of the clamp device 1 with respect to the pair of pipe members 2 can be easily performed.

Further, the present invention is not limited to the above-mentioned embodiments, and various design modifications may be made without departing from the scope of the invention.

For example, in the above-mentioned embodiment, while the pair of pad members 14 and 20 are swingably supported by each of the fixed-side clamping portion 10A and the movable-side clamping portion 10B, the pad members 14 and 20 can also be non-swingably fixed to the pad support block 13.

In addition, each of the pad members 14 and 20 of the fixed-side clamping portion 10A and the movable-side clamping portion 10B do not necessarily have to be provided in pairs, but only one may be provided.

Further, the shapes of the fixed-side clamping portion 10A and the movable-side clamping portion 10B are not limited to those of the above-mentioned embodiment. As long as it is capable to clamp the outer circumferential surfaces 2p of the pair of pipe members 2, various shapes may be employed.

In addition, in the above-mentioned embodiment, while the projecting pieces 24 are provided only on the pad member 14 on the side of the fixed-side clamping portion 10A, the projecting pieces 24 may be provided on the pad member 20 on the side of the movable-side clamping portion 10B. In addition, the projecting pieces 24 may be provided only on the pad member 20 on the side of the movable-side clamping portion 10B.

### REFERENCE SIGNS LIST

1 Clamp device
2 Pipe member
2e End surface
10A Fixed-side clamping portion (clamping portion on fixed side)
10B Movable-side clamping portion (clamping portion on movable side)
13, 19 Pad support block (support member)
14, 20 Pad member
14cf, 20cf Flat surface
24 Projecting piece

1. A clamp device configured to clamp outer circumferential surfaces of a pair of pipe members while having end surfaces of the pair of pipe members to be welded facing each other,
the clamp device comprising:
a plurality of clamping portions configured to clamp the outer circumferential surfaces of the pair of pipe members; and
a projecting piece that is provided on at least one of the clamping portions and that is inserted between the end surfaces of the pair of pipe members.

2. The clamp device according to claim 1, wherein the clamping portions have a flat surface configured to abut the outer circumferential surface of the pair of pipe members, and
the projecting piece is provided so as to protrude from the flat surface.

3. The clamp device according to claim 2, wherein the clamping portion comprises:
a support member; and
a pair of pad members that are swingably supported by the support member, each of the pair of pad members having the flat surface, and
wherein each of the flat surfaces of the pair of pad members receives a pressing load and abuts the outer circumferential surfaces of the pair of pipe members.

3. The clamp device according to claim 3, wherein the clamping portion is constituted by:
a fixed-side clamping portion; and
a movable-side clamping portion that approaches or moves away with respect to the fixed-side clamping portion, and
the projecting piece is provided only on the pad member of the fixed-side clamping portion.
